(19) United States
(12) Patent Application Publication
(10) Pub. No.: US 2026/0061756 A1
(43) Pub. Date: Mar. 5, 2026

(54) Aqueous Adhesive Composition For Textile Printing, Transport Belt, And Textile Printing Apparatus

(71) Applicant: SEIKO EPSON CORPORATION, Tokyo (JP)

(72) Inventors: Koichi TERAO, Suwa (JP); Soichi YAMAZAKI, Shiojiri (JP); Nikako TSUKIJI, Matsumoto (JP); Harunobu KOMATSU, Matsumoto (JP)

(21) Appl. No.: 19/314,130

(22) Filed: Aug. 29, 2025

(30) Foreign Application Priority Data
Aug. 30, 2024 (JP) 2024-148498

(51) Int. Cl. B41J 3/407; B41J 3/28; B41J 11/00

(52) U.S. Cl. CPC B41J 3/4078; B41J 3/28; B41J 11/007

(57) ABSTRACT

An aqueous adhesive composition for textile printing of the present disclosure contains water, a (meth)acrylic resin, and a preservative.

The present application is based on, and claims priority from JP Application Serial Number 2024-148498, filed Aug. 30, 2024, the disclosure of which is hereby incorporated by reference herein in its entirety.

### BACKGROUND

### 1. Technical Field

The present disclosure relates to an aqueous adhesive composition for textile printing, a transport belt, and a textile printing apparatus.

### 2. Related Art

In a textile printing method in which dyeing is performed by applying an ink composition to a fabric as a recording medium, an adhesive layer is formed on a surface of a transport belt transporting the fabric, the surface being in contact with the fabric. According to this, the fabric can be held on the transport belt while being caused to adhere thereto, and the fabric can be stably transported.

In order to form such an adhesive layer, a liquid base adhesive containing an adhesive is used.

The adhesive layer is required to have appropriate adhesive strength capable of suitably attaching and detaching the fabric fixed to the transport belt, and water resistance and mechanical strength capable of withstanding water washing. Therefore, a base adhesive in which a hydrophobic resin is dissolved in an organic solvent has been used.

The base adhesive containing an organic solvent, in which the organic solvent volatilizes at the time of application to the transport belt, puts many restrictions on the surrounding environment such as the necessity of sufficient ventilation. Therefore, there is a demand for an aqueous base adhesive from which an organic solvent does not volatilize. As such an aqueous base adhesive, those described in JP-A-59-53790 have been proposed.

However, such an aqueous base adhesive has a problem in that it is easily decomposed due to microorganisms.

### SUMMARY

The present disclosure has been made to solve the above problem, and can be implemented as the following application examples.

An aqueous adhesive composition for textile printing according to an application example of the present disclosure contains water, a (meth)acrylic resin, and a preservative.

A transport belt according to an application example of the present disclosure is a transport belt transporting a fabric on which printing by textile printing is performed, the transport belt including an adhesive layer formed of a material containing a (meth)acrylic resin and a preservative on a surface being in contact with the fabric.

A textile printing apparatus according to an application example of the present disclosure includes the transport belt according to the application example of the present disclosure, and an ink jet head including a nozzle ejecting ink onto the fabric being transported by the transport belt.

### BRIEF DESCRIPTION OF THE DRAWINGS

FIG. 1 is a schematic configuration diagram of a textile printing apparatus according to an embodiment of the present disclosure.

FIG. 2 is a diagram showing a state in which a transport apparatus included in the textile printing apparatus shown in FIG. 1 is executing a leveling step.

FIG. 3 is a flowchart for describing an example of an adhesive layer forming method.

FIG. 4 is a table collectively showing the kinds and the used amounts of raw materials used in Synthesis Examples 1 to 10.

FIG. 5 is a table collectively showing the kinds and the used amounts of raw materials used in Synthesis Examples 11 to 18.

FIG. 6 is a table collectively showing the compositions of aqueous adhesive compositions for textile printing of Examples 1 to 10.

FIG. 7 is a table collectively showing the compositions of aqueous adhesive compositions for textile printing of Examples 11 to 18 and Comparative Example 1.

FIG. 8 is a table collectively showing the evaluation results of Examples and Comparative Example.

### DESCRIPTION OF EMBODIMENTS

Preferred embodiments of the present disclosure will be described below in detail.

### [1] Aqueous Adhesive Composition for Textile Printing

First, an aqueous adhesive composition for textile printing of the present disclosure will be described.

The aqueous adhesive composition for textile printing of the present disclosure is used for forming an adhesive layer provided on a surface of a transport belt transporting a fabric on which printing by textile printing is performed, the surface being in contact with the fabric.

The aqueous adhesive composition for textile printing of the present disclosure contains water, a (meth)acrylic resin, and a preservative. According to this, since it is not necessary to use an organic solvent, it is not necessary to consider problems due to the use of the organic solvent, more specifically, restrictions on the surrounding environment due to the volatilization of the organic solvent. In addition, in the aqueous adhesive composition for textile printing, the occurrence of decomposition due to microorganisms can be suitably prevented. In addition, by forming an adhesive layer using such an aqueous adhesive composition for textile printing, a fabric can be stably fixed to the transport belt during printing, and a recorded matter obtained by printing can be suitably peeled off from the transport belt.

A transport belt including an adhesive layer formed using the aqueous adhesive composition for textile printing of the present disclosure and a textile printing apparatus including the transport belt will be described below in detail.

### [1-1] Water

The aqueous adhesive composition for textile printing contains water.

Water is a component applying fluidity to the aqueous adhesive composition for textile printing.

In the aqueous adhesive composition for textile printing, water functions as a solvent for dissolving or a dispersion medium for dispersing components other than water, such as the (meth)acrylic resin and the preservative.

The content of water in the aqueous adhesive composition for textile printing is not particularly limited, but is preferably 30.0% by mass or more and 80.0% by mass or less, and more preferably 35.0% by mass or more and 70.0% by mass or less. According to this, the fluidity and viscosity of the aqueous adhesive composition for textile printing can be made more suitable, and the applicability of the aqueous adhesive composition for textile printing and the uniformity of the thickness of an adhesive layer formed using the aqueous adhesive composition for textile printing can be made better.

### [1-2] (Meth)acrylic Resin

The aqueous adhesive composition for textile printing contains a (meth)acrylic resin.

The (meth)acrylic resin has a function of applying adhesiveness to the adhesive layer formed of the aqueous adhesive composition for textile printing.

In particular, among various adhesive components, by using the (meth)acrylic resin, the adhesive strength of the adhesive layer can be made more appropriate. In addition, the water resistance and mechanical strength of the adhesive layer can also be made better. According to this, for example, when the adhesive layer formed using the aqueous adhesive composition for textile printing is brushed with water, an unintentional decrease in the adhesive strength can be more suitably inhibited.

The (meth)acrylic resin may be a water-soluble resin, or may be an emulsion dispersed in an aqueous dispersion medium. In particular, when the (meth)acrylic resin is an emulsion synthesized by emulsion polymerization, the adhesive strength of the adhesive layer can be made more appropriate, and the water resistance and mechanical strength of the adhesive layer can also be made even better. Further, it is particularly advantageous in terms of the uniformization of the film thickness of the adhesive layer and the uniformization of surface properties.

The glass transition temperature of the (meth)acrylic resin is preferably −40° C. or higher and −10° C. or lower, more preferably −35° C. or higher and −12° C. or lower, and even more preferably −30° C. or higher and −15° C. or lower. According to this, the adhesive strength of the adhesive layer formed of the aqueous adhesive composition for textile printing can be made more suitable, the fabric can be more stably fixed to the transport belt during printing, and the recorded matter obtained by printing can be more suitably peeled off from the transport belt.

The (meth)acrylic resin is not particularly limited so long as it is a polymer containing a (meth)acrylic monomer such as (meth)acrylic acid or (meth)acrylate as at least part of monomer components. For example, the (meth)acrylic resin may be a homopolymer obtained by polymerizing one kind of (meth)acrylic monomer, or may be a copolymer containing a plurality of kinds of (meth)acrylic monomers as monomer components. In addition, the (meth)acrylic resin may be a copolymer containing a monomer other than the (meth)acrylic monomer as a monomer component in addition to the (meth)acrylic monomer.

The (meth)acrylic resin constituting the aqueous adhesive composition for textile printing of the present disclosure may contain a plurality of different kinds of polymers. For example, the (meth)acrylic resin may be obtained by blending a plurality of kinds of polymers synthesized under different conditions.

The (meth)acrylic monomer is not particularly limited, and examples thereof include a (meth)acrylic monomer having an acidic group, a (meth)acrylic monomer having an ester structure, and a (meth)acrylic monomer having an amide structure. Examples of the (meth)acrylic monomer having an acidic group include acrylic acid and methacrylic acid. Examples of the (meth)acrylic monomer having an ester structure include methyl acrylate, methyl methacrylate, ethyl acrylate, ethyl methacrylate, n-propyl acrylate, n-propyl methacrylate, butyl acrylate, butyl methacrylate, lauryl acrylate, lauryl methacrylate, isoamyl acrylate, isoamyl methacrylate, 2-ethylhexyl acrylate, 2-ethylhexyl methacrylate, cyclohexyl acrylate, and cyclohexyl methacrylate. Examples of the (meth)acrylic monomer having an amide structure include acrylamide and methacrylamide.

The monomer other than the (meth)acrylic monomer is not particularly limited, and examples thereof include styrene and acrylonitrile.

The (meth)acrylic resin preferably contains, as a constituent monomer, a first monomer having a glass transition temperature when formed into a homopolymer of-60° C. or lower. According to this, the adhesive strength of the adhesive layer formed of the aqueous adhesive composition for textile printing can be more suitably increased, and the fabric can be more stably fixed to the transport belt.

For the measurement of the glass transition temperature of the homopolymer, a homopolymer having a number average molecular weight of 100,000 or more and 5,000,000 or less can be used. In the homopolymer having a number average molecular weight in such a range, the influence of the molecular weight on the glass transition temperature is negligibly small.

The glass transition temperature of the homopolymer of the first monomer may be −60° C. or lower, but is preferably −100° C. or higher and −62° C. or lower, and more preferably −90° C. or higher and −64° C. or lower. According to this, the above-described effect is more remarkably exhibited.

Preferred examples of the first monomer include 2-ethylhexyl acrylate.

When the (meth)acrylic resin contains the first monomer as a constituent monomer, the proportion of the first monomer in all monomers constituting the (meth)acrylic resin is preferably 2.0% by mass or more and 15.0% by mass or less, more preferably 2.5% by mass or more and 10.0% by mass or less, and even more preferably 3.0% by mass or more and 8.0% by mass or less. According to this, the adhesive strength of the adhesive layer formed of the aqueous adhesive composition for textile printing can be made more suitable, the fabric can be more stably fixed to the transport belt during printing, and the recorded matter obtained by printing can be more suitably peeled off from the transport belt.

The (meth)acrylic resin preferably contains, as a constituent monomer, a second monomer having a glass transition temperature when formed into a homopolymer of 40° C. or higher. According to this, the mechanical strength of the adhesive layer formed of the aqueous adhesive composition for textile printing can be made better. In addition, the adhesive strength of the adhesive layer formed of the aqueous adhesive composition for textile printing can be made more suitable, the fabric can be sufficiently stably fixed to the transport belt during printing, and the recorded matter obtained by printing can be more suitably peeled off from the transport belt.

The glass transition temperature of the homopolymer of the second monomer may be 40° C. or higher, but is preferably 45° C. or higher and 150° C. or lower, more preferably 50° C. or higher and 140° C. or lower, and even more preferably 60° C. or higher and 135° C. or lower. According to this, the above-described effect is more remarkably exhibited.

The (meth)acrylic resin may contain a monomer having an acidic functional group as the second monomer. According to this, the storage stability of the aqueous adhesive composition for textile printing can be made better.

Preferred examples of the second monomer include acrylic acid, methacrylic acid, methyl methacrylate, ethyl methacrylate, cyclohexyl acrylate, and cyclohexyl methacrylate.

When the (meth)acrylic resin contains the second monomer as a constituent monomer, the proportion of the second monomer in all the monomers constituting the (meth)acrylic resin is preferably 5.0% by mass or more and 20.0% by mass or less, and more preferably 7.0% by mass or more and 19.7% by mass or less. According to this, the mechanical strength of the adhesive layer formed of the aqueous adhesive composition for textile printing can be made even better. In addition, the adhesive strength of the adhesive layer formed of the aqueous adhesive composition for textile printing can be made more suitable, the fabric can be sufficiently stably fixed to the transport belt during printing, and the recorded matter obtained by printing can be even more suitably peeled off from the transport belt.

When the (meth)acrylic resin contains the first monomer and the second monomer as constituent monomers, the mass proportion of the second monomer in the (meth)acrylic resin is preferably larger than the mass proportion of the first monomer. According to this, the adhesive strength of the adhesive layer formed of the aqueous adhesive composition for textile printing can be made more suitable, the fabric can be even more stably fixed to the transport belt during printing, and the recorded matter obtained by printing can be even more suitably peeled off from the transport belt. In addition, the mechanical strength of the adhesive layer formed of the aqueous adhesive composition for textile printing can be made better.

In particular, when the mass proportion of the first monomer in the (meth)acrylic resin is represented by X1 [% by mass] and the mass proportion of the second monomer is represented by X2 [% by mass], a relation 1.1≤X2/X1≤5.0 is preferably satisfied, a relation 1.2≤X2/X1≤4.5 is more preferably satisfied, and a relation 1.3≤X2/X1≤3.8 is even more preferably satisfied. According to this, the above-described effect is more remarkably exhibited.

The (meth)acrylic resin preferably contains, as a constituent monomer, a third monomer having a glass transition temperature when formed into a homopolymer of higher than −60° C. and lower than 40° C., in addition to the first monomer and the second monomer. According to this, the adhesive strength of the adhesive layer formed of the aqueous adhesive composition for textile printing can be made more suitable, the fabric can be more stably fixed to the transport belt during printing, and the recorded matter obtained by printing can be more suitably peeled off from the transport belt.

The glass transition temperature of the homopolymer of the third monomer may be higher than −60° C. and lower than 40° C., but is preferably −58° C. or higher and 30° C. or lower, and more preferably −56° C. or higher and 25° C. or lower. According to this, the above-described effect is more remarkably exhibited.

Preferred examples of the third monomer include butyl acrylate, butyl methacrylate, and isoamyl acrylate.

When the (meth)acrylic resin contains the third monomer as a constituent monomer, the proportion of the third monomer in all the monomers constituting the (meth)acrylic resin is preferably 63.0% by mass or more and 92.0% by mass or less, more preferably 70.0% by mass or more and 88.0% by mass or less, and even more preferably 73.0% by mass or more and 87.0% by mass or less. According to this, the adhesive strength of the adhesive layer formed of the aqueous adhesive composition for textile printing can be made more suitable, the fabric can be even more stably fixed to the transport belt during printing, and the recorded matter obtained by printing can be even more suitably peeled off from the transport belt.

When the mass proportion of the first monomer in the (meth)acrylic resin is represented by X1 [% by mass] and the mass proportion of the third monomer is represented by X3 [% by mass], a relation 4.0≤X3/X1≤40.0 is preferably satisfied, a relation 10.0≤X3/X1≤30.0 is more preferably satisfied, and a relation 12.0≤X3/X1≤20.0 is even more preferably satisfied. According to this, the above-described effect is more remarkably exhibited.

When the mass proportion of the second monomer in the (meth)acrylic resin is represented by X2 [% by mass] and the mass proportion of the third monomer is represented by X3 [% by mass], a relation 2.0≤X3/X2≤20.0 is preferably satisfied, a relation 3.0≤X3/X2≤18.0 is more preferably satisfied, and a relation 3.7≤X3/X2≤12.0 is even more preferably satisfied. According to this, the above-described effect is more remarkably exhibited.

The content of the (meth)acrylic resin in the aqueous adhesive composition for textile printing is preferably 20.0% by mass or more and 70.0% by mass or less, and more preferably 30.0% by mass or more and 60.0% by mass or less. According to this, the mechanical strength of the adhesive layer formed of the aqueous adhesive composition for textile printing can be made better. In addition, the adhesive strength of the adhesive layer formed of the aqueous adhesive composition for textile printing can be made more suitable, and the fabric can be more stably fixed to the transport belt during printing, and the recorded matter obtained by printing can be more suitably peeled off from the transport belt. In addition, the applicability and storage stability of the aqueous adhesive composition for textile printing can be made better.

### [1-3] Preservative

The aqueous adhesive composition for textile printing contains a preservative.

The preservative has a function of preventing the occurrence of decomposition due to microorganisms in the aqueous adhesive composition for textile printing or the adhesive layer formed using the aqueous adhesive composition for textile printing.

The preservative may be an inorganic preservative, but is preferably an organic preservative. According to this, the storage stability of the aqueous adhesive composition for textile printing can be made better.

Examples of the inorganic preservative include ones in which silver, zinc, or copper having antimicrobial properties is supported with zeolite, silica gel, potassium titanate whiskers, magnesium oxide whiskers, or the like used as a carrier.

Examples of the organic preservative include a thiazoline-based antibacterial agent, an imidazole-based antibacterial agent, an ester-based antibacterial agent, and a carboxylic acid-based antibacterial agent.

Examples of the thiazoline-based antibacterial agent include 2-n-octyl-4-isothiazolin-3-one, 1,2-benzisothiazol-3(2H)-one, methylisothiazolinone, and 5-chloro-2-methyl-4-isothiazolin-3-one.

Examples of the imidazole-based antibacterial agent include 2-(4-thiazolyl)-benzimidazole and methyl-2-benzimidazole carbamate.

Examples of the ester-based antibacterial agent include glycerol monolaurate.

Examples of the carboxylic acid-based antibacterial agent include sorbic acid and salts thereof. Examples of the salt include a potassium salt.

Among these, the preservative is preferably a thiazoline-based antibacterial agent, and more preferably 1,2-benzisothiazol-3(2H)-one. According to this, the affinity with the above-described (meth)acrylic resin (in particular, the (meth)acrylic resin containing the preferable first monomer, second monomer, and third monomer as constituent monomers) can be made better. As a result, the preservative can be more uniformly dispersed in the adhesive layer, and the mechanical strength, water resistance, preservative properties, and the like of the adhesive layer can be made better.

The content of the preservative in the aqueous adhesive composition for textile printing is not particularly limited, but is preferably 0.001% by mass or more and 0.10% by mass or less, more preferably 0.005% by mass or more and 0.05% by mass or less, and even more preferably 0.01% by mass or more and 0.04% by mass or less. According to this, the above-described effect due to the inclusion of the preservative is more remarkably exhibited, and the adhesiveness, durability, and the like of the adhesive layer formed using the aqueous adhesive composition for textile printing can be made more suitable.

When the content of the (meth)acrylic resin in the aqueous adhesive composition for textile printing is represented by XA [% by mass] and the content of the preservative is represented by XP [% by mass], a relation 0.002≤XP/XA≤0.1 is preferably satisfied, a relation 0.003≤XP/XA≤0.05 is more preferably satisfied, and a relation 0.005≤XP/XA≤0.02 is even more preferably satisfied. According to this, the above-described effect is more remarkably exhibited.

### [1-4] Surfactant

The aqueous adhesive composition for textile printing may contain a surfactant.

The surfactant is not particularly limited, and examples thereof include an anionic surfactant, a nonionic surfactant, and a cationic surfactant.

Examples of the anionic surfactant include alkyl sulfocarboxylates, alkyl diphenyl ether disulfonates, α-olefin sulfonates, polyoxyalkylene alkyl ether acetates, N-acylamino acids and salts thereof, N-acylmethyl taurine salts, alkyl sulfates such as ammonium lauryl sulfate and sodium lauryl sulfate, polyoxyalkylene alkyl ether sulfates, polyoxyalkylene alkyl ether phosphates, rosin acid soap, castor oil sulfate, lauryl alcohol sulfate, alkylphenol type phosphates, alkyl type phosphates, alkylaryl sulfonates, diethyl sulfosuccinate, diethylhexyl sulfosuccinate, and dioctyl sulfosuccinate. Examples of commercially available products of the anionic surfactant include Eleminol CLS-20 (a trade name, manufactured by Sanyo Chemical Industries, Ltd.); Emal 2F-30, Latemul AD-25, and Latemul E-118B (trade names, manufactured by Kao Corporation); and Newcol 2320-SN (a trade name, manufactured by Nippon Nyukazai Co., Ltd.) (Newcol is a registered trademark).

Examples of the nonionic surfactant include acetylene glycol surfactants, silicone surfactants, polyoxyethylene alkyl ethers, polyoxyethylene alkylphenyl ethers, polyoxyethylene fatty acid esters, polyoxyethylene hydrogenated castor oil, propylene glycol fatty acid esters, glycerin fatty acid esters, polyglycerin fatty acid esters, sorbitan fatty acid esters, sucrose fatty acid esters, alkyl polyglycosides, alkyl diethanolamides, and alkylamine oxides. Examples of commercially available products of the nonionic surfactant include Emulgen 123p, 430, and 1108 (trade names, manufactured by Kao Corporation); Newcol 1006, 1008, and 1020 (trade names, manufactured by Nippon Nyukazai Co., Ltd.); Noigen DL 0415, ET-116B, ET-106A, DH-0300, YX-400, and EA-160 (trade names, manufactured by DKS Co. Ltd.).

Examples of the cationic surfactant include alkylamine salts, fatty acid amide amine salts, monoalkyl type quaternary ammonium salts, dialkyl type quaternary ammonium salts, trialkyl type quaternary ammonium salts, benzalkonium type quaternary ammonium salts, benzethonium chloride, and alkylpyridinium salts.

Among these, the anionic surfactant is preferable, and combined use of the anionic surfactant and a polyoxyethylene alkyl ether-based nonionic surfactant is more preferable. According to this, the durability of the adhesive layer formed using the aqueous adhesive composition for textile printing becomes better.

The content of the surfactant in the aqueous adhesive composition for textile printing is preferably 1.0% by mass or more and 7.0% by mass or less, and more preferably 2.0% by mass or more and 6.0% by mass or less.

### [1-5] pH Adjuster

The aqueous adhesive composition for textile printing may contain a pH adjuster.

The pH adjuster is not particularly limited, and examples thereof include inorganic acids (e.g., sulfuric acid, hydrochloric acid, nitric acid, and the like), inorganic bases (e.g., lithium hydroxide, sodium hydroxide, potassium hydroxide, ammonia or ammonium salts, and the like), organic bases (triethanolamine, diethanolamine, monoethanolamine, and tripropanolamine), and organic acids (e.g., adipic acid, citric acid, succinic acid, and the like).

Among these, ammonia or an ammonium salt is preferable. By using such a pH adjuster, when the adhesive layer is formed, ammonia volatilizes, and the (meth)acrylic resin easily adheres by itself to form a coating film into which water is not likely to penetrate. Therefore, the durability of the adhesive strength and the water resistance of the adhesive layer formed on the transport belt improve, and the adhesiveness tends to be further maintained in a wide temperature range.

The content of the pH adjuster in the aqueous adhesive composition for textile printing is preferably 0.05% by mass or more and 1.50% by mass or less, more preferably 0.10% by mass or more and 1.00% by mass or less, and even more preferably 0.15% by mass or more and 0.50% by mass or less. The pH adjuster may be contained such that the pH of the aqueous adhesive composition for textile printing is 7.7 or more and 9.0 or less, or may be contained such that it is 8.0 or more and 8.7 or less. When the content of the pH adjuster is within the above range, the peelability, the adhesiveness, and the washing resistance of the adhesive layer to be obtained further improve, and the dispersion stability tends to further improve.

### [1-6] Tackifier

The aqueous adhesive composition for textile printing may contain a tackifier.

Examples of the tackifier include a rosin-based compound, a terpene-based compound, and a hydrocarbon resin. More specific examples thereof include rosin-based compounds such as natural rosins, modified rosins, glycerol esters of natural rosins, glycerol esters of modified rosins, pentaerythritol esters of natural rosins, and pentaerythritol esters of modified rosins; terpene-based compounds such as copolymers of natural terpenes, three dimensional polymers of natural terpenes, aromatic modified terpene resins, hydrogenated derivatives of aromatic modified terpene resins, terpene phenol resins, and terpene resins (monoterpenes, diterpenes, triterpenes, polyterpenes, and the like); and hydrocarbon resins such as aliphatic petroleum hydrocarbon resins (C5-based resins), hydrogenated derivatives of aliphatic petroleum hydrocarbon resins, aromatic petroleum hydrocarbon resins (C9-based resins) such as styrene oligomers, and hydrogenated derivatives of aromatic petroleum hydrocarbon resins.

When the aqueous adhesive composition for textile printing contains the tackifier, the content of the tackifier in the aqueous adhesive composition for textile printing is not particularly limited, but is preferably 5.0% by mass or less, more preferably 4.0% by mass or less, and even more preferably 0.1% by mass or more and 3.8% by mass or less. According to this, the adhesive strength of the adhesive layer formed using the aqueous adhesive composition for textile printing is made more suitable, and the effect of inhibiting a decrease in the adhesive strength when the adhesive layer is brushed is easily maintained for a longer period of time.

### [1-7] Coloring Material

The aqueous adhesive composition for textile printing may contain a coloring material.

As the coloring material, for example, various pigments and various dyes can be used.

When the aqueous adhesive composition for textile printing contains the coloring material, the content of the coloring material in the aqueous adhesive composition for textile printing is preferably 1.0% by mass or less, and more preferably 0.5% by mass or less.

### [1-8] Other Components

The aqueous adhesive composition for textile printing may contain components other than those described above. Hereinafter, such components are also referred to as “other components.”

Examples of the other components include resin materials other than the (meth)acrylic resin, antioxidants, colorants, antistatic agents, flame retardants, flame retardant aids, ultraviolet absorbers, aggregation inhibitors, processing aids, and plasticizers.

Examples of the resin material other than the (meth)acrylic resin include urethane resins, silicone resins, and various elastomers (rubber-based materials).

However, the content of the other components in the aqueous adhesive composition for textile printing is preferably 10.0% by mass or less, more preferably 5.0% by mass or less, and even more preferably 3.0% by mass or less.

In particular, the aqueous adhesive composition for textile printing preferably does not contain an organic solvent or contains only a small amount of it from the viewpoint of reducing restrictions on the surrounding environment due to the volatilization of the organic solvent. More specifically, the content of the organic solvent in the aqueous adhesive composition for textile printing is preferably 5.0% by mass or less, more preferably 2.5% by mass or less, and even more preferably 0.5% by mass or less.

### [1-9] Other Conditions

The viscosity at 23° C. of the aqueous adhesive composition for textile printing is not particularly limited, but is preferably 5 mPa·s or more and 1,000 mPa·s or less, and more preferably 10 mPa·s or more and 300 mPa·s or less. According to this, the handleability at the time of applying the aqueous adhesive composition for textile printing becomes better, and unintentional variations in the thickness or surface properties of the adhesive layer to be formed can be more suitably prevented.

The storage modulus at 23° C. of the adhesive layer formed using the aqueous adhesive composition for textile printing is preferably 1.5×10⁵ Pa or more and 5.0×10⁵ Pa or less, more preferably 1.6×10⁵ Pa or more and 4.8×10⁵ Pa or less, and even more preferably 2.0×10⁵ Pa or more and 4.5×10⁵ Pa or less.

The method for forming the adhesive layer for measuring the storage modulus is not particularly limited. For example, a method can be employed in which the aqueous adhesive composition for textile printing is applied to a 25 mm wide glass slide in an environment at 23° C. so as to be 0.2 mm thick, and dried under conditions of 50% RH, 23° C., and 12 hours.

### [2] Textile Printing Apparatus and Transport Belt

Next, a transport belt and a textile printing apparatus of the present disclosure will be described.

The transport belt of the present disclosure is a transport belt transporting a fabric on which printing by textile printing is performed, the transport belt including an adhesive layer formed of a material containing a (meth)acrylic resin and a preservative on a surface being in contact with the fabric. According to this, it is possible to provide a transport belt in which the occurrence of decomposition due to microorganisms is suitably prevented, the fabric can be stably fixed to the transport belt during printing, and a recorded matter obtained by printing can be suitably peeled off from the transport belt. In particular, since the adhesive layer can be formed using an aqueous adhesive composition for textile printing containing water, it is not necessary to use an organic solvent in the aqueous adhesive composition for textile printing, and it is not necessary to consider problems due to the use of the organic solvent, more specifically, restrictions on the surrounding environment, loads on the environment, and the like due to the volatilization of the organic solvent.

The textile printing apparatus of the present disclosure includes the transport belt of the present disclosure and an ink jet head having a nozzle ejecting ink onto a fabric being transported by the transport belt. According to this, it is possible to provide a textile printing apparatus including a transport belt in which the occurrence of decomposition due to microorganisms is suitably prevented, the fabric can be stably fixed during printing, and the recorded matter obtained by printing can be suitably peeled off. In particular, since the adhesive layer can be formed using an aqueous adhesive composition for textile printing containing water, it is not necessary to use an organic solvent in the aqueous adhesive composition for textile printing, and it is not necessary to consider problems due to the use of the organic solvent, more specifically, restrictions on the surrounding environment, loads on the environment, and the like due to the volatilization of the organic solvent.

The adhesive layer constituting the transport belt of the present disclosure can be suitably formed using the above-described aqueous adhesive composition for textile printing of the present disclosure.

A more specific embodiment of the transport belt and the textile printing apparatus of the present disclosure will be described below with reference to the drawings.

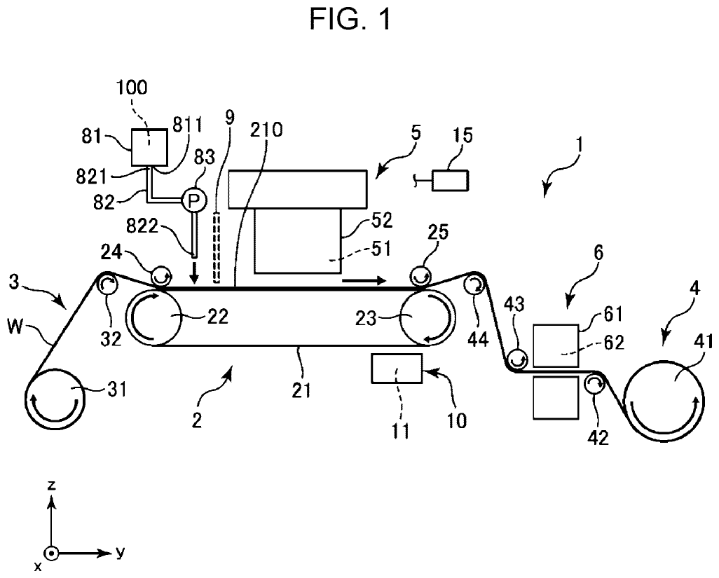

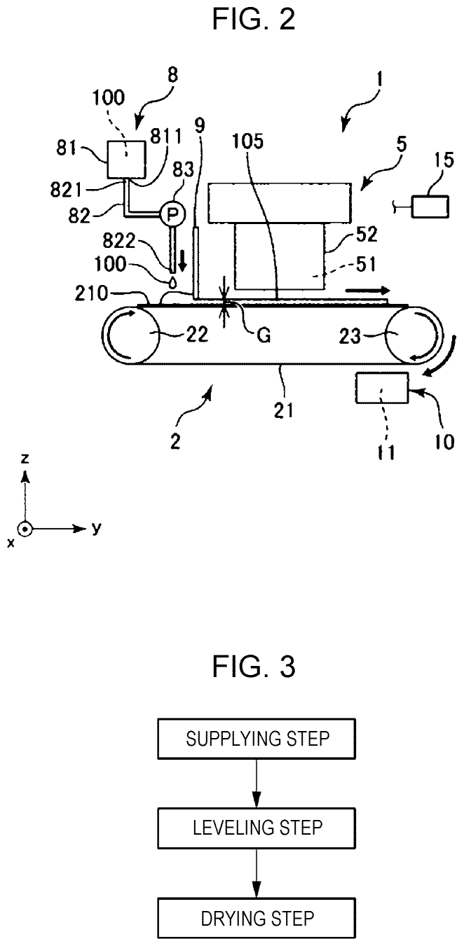

FIG. 1 is a schematic configuration diagram of a textile printing apparatus according to an embodiment of the present disclosure. FIG. 2 is a diagram showing a state in which a transport apparatus included in the textile printing apparatus shown in FIG. 1 is executing a leveling step. FIG. 3 is a flowchart for describing an example of an adhesive layer forming method.

Note that, for convenience of description, FIG. 1 and FIG. 2 show an x axis, a y axis, and a z axis as three axes orthogonal to each other. The x-axis is an axis along one direction of the horizontal directions (the width direction of the transport belt), the y-axis is an axis along the horizontal direction perpendicular to the x-axis (the travel direction of the transport belt), and the z-axis is an axis along the vertical direction (the up-down direction in the drawings). In addition, the tip end side of each shown arrow is “positive side (+ side),” and the basal end side is “negative side (− side).” Further, the upper side in FIG. 1 and FIG. 2 is referred to as “up” or “above,” and the lower side is referred to as “down” or “below.”

As shown in FIG. 1 and FIG. 2, a textile printing apparatus 1 includes a transport apparatus 2 including a transport belt 21 transporting a fabric W, a feeding apparatus 3 feeding the long fabric W wound in a roll shape, a take-up apparatus 4 taking up the printed fabric W, a printing section 5 applying ink onto the fabric W being transported by the transport belt 21 to perform printing, and an ink drying section 6 drying the ink on the fabric W.

In the present embodiment, a direction orthogonal to a transport direction in which the fabric W is transported is an x-axis direction, a direction parallel to the transport direction is a y-axis direction, and a direction orthogonal to the x-axis direction and the y-axis direction is a z-axis direction.

As the fabric W, a woven fabric, a knitted fabric, a nonwoven fabric, or the like of natural fibers such as cotton, silk, and wool, chemical fibers such as nylon, or composite fibers obtained by mixing these fibers can be used. The fabric W may be clothes, other furnishing products, or the like. Clothes or other furnishing products also include, for example, furniture such as sewn T-shirts, handkerchiefs, scarves, towels, carrier bags, cloth bags, curtains, sheets, and bed covers, as well as fabrics before and after cutting that exist as parts in a state before sewing.

The transport apparatus 2 includes a drive roller 22 and a driven roller 23 disposed separated from each other in the y-axis direction, the transport belt 21 wound around the drive roller 22 and the driven roller 23 and supporting the fabric W on its upper surface (support surface), and tensioners 24 and 25 applying tension to the fabric W between the drive roller 22 and the driven roller 23.

A motor (not shown) is connected to the drive roller 22, and the drive roller 22 can be rotationally driven by the operation of the motor. The driven roller 23, to which the rotational force of the drive roller 22 is transmitted via the transport belt 21, can rotate in conjunction with the drive roller 22.

The transport belt 21 is an endless belt in which an adhesive layer having adhesiveness is formed on the front surface thereof. A portion of the fabric W is adhesively fixed to this adhesive layer, and the fabric W is transported to the + side in the y-axis direction. During this transportation, desired printing is performed on the fabric W. After the printing is performed, the fabric W peels off from the transport belt 21. As shown in FIG. 2, the adhesive layer is formed by supplying an application liquid 100 from an application liquid supply section 8. A surface of the transport belt 21 being in contact with the fabric W is an application surface 210 to which the application liquid 100 is applied. As the application liquid 100, the above-described aqueous adhesive composition for textile printing of the present disclosure is suitably used.

Like the drive roller 22 and the driven roller 23, the tensioners 24 and 25 are also disposed separated from each other in the y-axis direction.

The tensioner 24 can hold the fabric W together with the transport belt 21 between the tensioner 24 and the drive roller 22, and the tensioner 25 can hold the fabric W together with the transport belt 21 between the tensioner 25 and the driven roller 23. According to this, the fabric W to which appropriate tension is applied by the tensioners 24 and 25 is transported while being adhesively fixed to the transport belt 21 in a state in which the tension is applied. Due to such a state, for example, the occurrence of wrinkling, sagging, or the like is reduced in the fabric W during transportation, and thus, when printing is performed, the printing is appropriate and high quality.

As shown in FIG. 1, the feeding apparatus 3 is disposed on the upstream side of the transport apparatus 2 in the sending direction of the fabric W, that is, on the − side in the y-axis direction. The feeding apparatus 3 includes a delivery roller (a feeding reel) 31 around which the fabric W is wound in a roll shape and that delivers the fabric W, and a tensioner 32 applying tension to the fabric W between the delivery roller 31 and the transport apparatus 2. A motor (not shown) is connected to the delivery roller 31, and the delivery roller 31 can be rotationally driven by the operation of the motor.

The take-up apparatus 4 is disposed on the downstream side of the driven roller 23 in the sending direction of the fabric W, that is, on the + side in the y-axis direction with respect to the transport apparatus 2. The take-up apparatus 4 includes a take-up roller 41 taking up the fabric W in a roll shape, and tensioners 42, 43, and 44 applying tension to the fabric W between the take-up roller 41 and the transport apparatus 2. A motor (not shown) is connected to the take-up roller 41, and the take-up roller 41 can be rotationally driven by the operation of the motor. The tensioners 42, 43, and 44 are arranged at intervals in this order in a direction away from the take-up roller 41.

The printing section 5 includes a carriage unit 52 having a plurality of ink jet heads 51 performing recording by printing by ejecting ink toward the fabric W, and an X-axis table (not shown) supporting the carriage unit 52 so as to be movable in the X-axis direction. Each of the ink jet heads 51 has, for example, a head body formed with an in-head flow path filled with ink inside, and many nozzle groups having openings.

In the head body, a piezoelectric element (piezoelectric body) corresponding to each ejection nozzle is provided, and when a voltage is applied to the piezoelectric element, ink is ejected as liquid droplets from the nozzle group.

Note that the ink jet head 51 is on standby at a standby position, which is a position away from the fabric W (the transport belt 21) in the x-axis direction when viewed from the z-axis direction, in a state where the ink is not ejected.

In the textile printing apparatus 1, the fabric W fed by the feeding apparatus 3 is intermittently fed to the + side in the y-axis direction in a fixed state in which the fabric W is adhesively fixed by the transport belt 21, and the ink is ejected from the nozzle group to the fabric W in the fixed state while the carriage unit 52 is reciprocated in the x-axis direction. According to this, a desired image pattern is formed on the fabric W, and printing is performed. Note that the image pattern may be printed in multiple colors or printed in a single color.

The ink includes, for example, four colors of cyan (C), magenta (M), yellow (Y), and black (K) in which a dye or a pigment as a coloring agent is contained in water as a solvent. The ink of each color is independently ejected from the ink jet head 51.

As shown in FIG. 1, the ink drying section 6 is disposed between the transport apparatus 2 and the take-up roller 41 of the take-up device 4 on the downstream side of the printing section 5 in the transport direction of the fabric W, that is, on the + side in the y-axis direction.

The ink drying section 6 includes a chamber 61 and a coil 62, which is a heat source (heater) disposed in the chamber 61. The coil 62 is formed of, for example, a nichrome wire, and is formed of a heating element generating heat by being supplied with electric power. The ink on the fabric W passing through the chamber 61 can be dried by the heat generated by the coil 62.

The textile printing apparatus 1 includes a controller 15 controlling the operation of each section of the textile printing apparatus 1 or the transport apparatus 2. That is, the controller 15 controls the drive roller 22, the delivery roller 31, the take-up roller 41, the ink jet head 51, the carriage unit 52, the coil 62, a liquid feeding pump 83, a coil 11, and the like to be driven at a desired timing and under desired conditions each. More specifically, the motor of the drive roller 22, the motor of the delivery roller 31, the motor of the take-up roller 41, the ink jet head 51, the carriage unit 52, the coil 62, the liquid feeding pump 83, and the coil 11 are each electrically connected to a power supply section (not shown), and the controller 15 controls an electricity supply condition from the power supply section to each of these sections, and drives each of these sections at a desired timing and under desired conditions (speed, temperature, and the like).

The controller 15 includes a semiconductor integrated circuit, and includes an arithmetic processing section, a control signal transmission and reception section, and a storage section. The storage section stores therein a program for executing the operation of each of the above-described sections, information on operation conditions, and the like.

In such a textile printing apparatus 1, when printing on the fabric W is not performed, the aqueous application liquid 100 is periodically supplied onto the transport belt 21 to form an adhesive layer. That is, in the textile printing apparatus 1, the application liquid supply section 8, a blade 9, and an adhesive drying section 10 included in the transport apparatus 2 are operated as described below, and thus a coating film 105 of the application liquid 100 and an adhesive layer obtained by drying the coating film are formed on the surface (the application surface 210) of the transport belt 21 on the fabric W side.

Next, the transport apparatus 2 will be described.

As shown in FIG. 1 and FIG. 2, the transport apparatus 2 includes the transport belt 21, the application liquid supply section 8 supplying the application liquid 100 to the application surface 210 of the transport belt 21 on the fabric W side, the blade 9 leveling the application liquid 100 supplied to the application surface 210, and the adhesive drying section 10 drying the coating film 105 obtained by passing through the blade 9. The application liquid supply section 8, the blade 9, and the adhesive drying section 10 may each be incorporated in the transport apparatus 2, or may be configured to be detachable.

The application liquid supply section 8 includes a storage section 81 storing the application liquid 100, a liquid feeding pipe 82 feeding the application liquid 100 in the storage section 81 to the vicinity of the application surface 210, and the liquid feeding pump 83 provided in the middle of the liquid feeding pipe 82, and performs a supplying step shown in FIG. 3 by these components.

The storage section 81 used in the supplying step is formed of a hard or flexible container capable of containing the application liquid 100, and by operating the liquid feeding pump 83, the application liquid 100 in the storage section 81 is discharged from a discharge port 811, fed via the liquid feeding pipe 82, and discharged and supplied from another end 822 of the liquid feeding pipe 82 toward the application surface 210.

In the present embodiment, when the application liquid supply section 8 supplies the application liquid 100, the transport belt 21 is continuously rotationally driven to travel. In this case, the traveling speed of the transport belt 21 is made constant. According to this, the portion to be supplied on the application surface 210 can be continuously changed while supplying the application liquid 100. Further, also in the leveling step described below, the leveling can be continuously performed.

The traveling speed of the transport belt 21 in the supplying step and the leveling step described below, that is, when the application liquid 100 is supplied and leveled is not particularly limited, but is preferably 4 mm/sec or more and 67 mm/sec or less, and more preferably 8 mm/sec or more and 33 mm/sec or less. With such a traveling speed, the application of the application liquid 100 can be quickly performed, and a more uniform and good coating film 105 can be obtained.

Note that in the present disclosure, the transport belt 21 may be rotationally driven intermittently. Further, the transport belt 21 may be rotationally driven at any timing and any speed.

The storage section 81 includes the discharge port 811 discharging the application liquid 100 stored therein. One end 821 of the liquid feeding pipe 82 is connected to the discharge port 811. The liquid feeding pipe 82 transports the application liquid 100 to the vicinity of the application surface 210. The other end 822 of the liquid feeding pipe 82 is positioned above the application surface 210 of the transport belt 21 and on the upstream side (the − side in the y-axis direction) of the printing section 5. Therefore, the application liquid 100 discharged from the other end 822 of the liquid feeding pipe 82 is dropped or jetted to a position biased to the − side in the y-axis direction, that is, a position biased toward the drive roller 22, on the application surface 210 of the transport belt 21.

Although not shown, the other end 822 of the liquid feeding pipe 82 branches into a plurality of pipes. The branched flow paths are arranged along the x-axis direction, that is, along the width direction of the transport belt 21. According to this, the application liquid 100 can be evenly (neither too much nor too little) and uniformly supplied to a necessary area of the application surface 210.

The other end 822 of the liquid feeding pipe 82 may be provided with a nozzle, an orifice, or the like.

Thus, the transport apparatus 2 includes the liquid feeding pipe 82 that is connected to the discharge port 811 and transports the application liquid 100 to the application surface 210. According to this, the degree of freedom of the installation position of the storage section 81 can be increased. Note that the liquid feeding pipe 82 may be omitted, and the liquid may be directly supplied from the discharge port 811 to the application surface 210 of the transport belt 21. In this case, the discharge port 811 is installed to face downward.

The supply amount of the application liquid 100 supplied from the liquid feeding pipe 82 onto the application surface 210 per unit time, that is, the sum of the supply amounts of the branched flow paths (hereinafter, simply referred to as “supply amount”) is not particularly limited, but is preferably 15 mL/min or more and 67 mL/min or less, and more preferably 22 mL/min or more and 50 mL/min or less. With such a supply amount, the application of the application liquid 100 can be quickly performed, and the leveling in the leveling step described below can be performed more uniformly and favorably.

The application liquid supply section 8 may continuously supply the application liquid 100 or may intermittently supply the application liquid 100.

In the present embodiment, the application liquid 100 is supplied by the operation of the liquid feeding pump 83 provided in the liquid feeding pipe 82, but the present disclosure is not limited thereto.

For example, a configuration may be adopted in which the storage section 81 is formed of a container having flexibility, a pressurizing section pressurizing the storage section 81 from the outside is provided, the storage section 81 is pressurized by the pressurizing section, the application liquid 100 in the storage section 81 is pushed out from the discharge port 811, fed by the liquid feeding pipe 82, discharged from the other end 822, and supplied to the application surface 210. In this case, examples of the pressurizing section include a configuration in which the storage section 81 is pressurized by air pressure and a configuration in which the storage section 81 is physically pressurized by a member such as a pressurizing plate or a pressurizing roller.

In addition, as another configuration, the application liquid 100 in the storage section 81 may be supplied to the application surface 210 by free fall through the liquid feeding pipe 82.

The blade 9 levels the application liquid 100 supplied to the application surface 210 of the traveling transport belt 21 to a uniform thickness. The application liquid 100 applied to the application surface 210 is uniformly leveled by the blade 9 in the leveling step shown in FIG. 3.

In the present embodiment, an application step of applying the application liquid 100 to the application surface 210 includes the supplying step and the leveling step.

The blade 9 used in the leveling step has an elongated shape extending in the width direction of the transport belt 21. The blade 9 is fixed in a state of being suspended above the transport belt 21 by a support (not shown).

The blade 9 is provided between the other end 822 of the liquid feeding pipe 82 and the printing section 5, that is, on the downstream side (the + side in the y-axis direction) of the other end 822 of the liquid feeding pipe 82.

The blade 9 is provided such that the lower end thereof, that is, the end on the − side in the z-axis direction, is separated from the application surface 210 by a predetermined distance G. This distance G is an important factor for determining the thickness of the application liquid 100 after the leveling step, that is, the coating film 105, and is particularly an important factor for determining the film thickness of the adhesive layer to be obtained. In determining the distance G, it is determined as appropriate in accordance with various conditions such as the above-described viscosity of the application liquid 100, the supply amount, and the desired adhesive strength of the adhesive layer. When at least one, particularly two or three of the viscosity of the application liquid 100, the supply amount, and the adhesive strength of the adhesive layer are in the above-described preferred ranges, the gap G is preferably 0.05 mm or more and 5 mm or less, and more preferably 0.1 mm or more and 0.5 mm or less. According to this, the coating film 105 having a more uniform thickness can be formed in the leveling step.

Such a distance G is preferably equal along the longitudinal direction of the blade 9, that is, the x-axis direction. According to this, the film thickness of the coating film 105 in the x-axis direction can be made uniform.

Thus, the blade 9 extends in the width direction of the transport belt 21, and is separated from the transport belt 21 by the predetermined distance G when the application liquid 100 is leveled. According to this, in the leveling step, the application liquid 100 can be more uniformly leveled in the entire area in the width direction of the transport belt 21. In addition, since the blade 9 is not in contact with the application surface 210 of the transport belt 21, damage to the transport belt 21 by the blade 9 can be prevented.

Note that the blade 9 may be in contact with the transport belt 21 at all times or at an appropriate time when the application liquid 100 is leveled.

The application liquid 100 on the application surface 210 supplied in the supplying step is transported to the + side in the y-axis direction by the traveling of the transport belt 21, and is leveled when passing through the gap by the distance G between the application surface 210 and the blade 9, and the thickness becomes uniform.

Note that the blade 9 may be installed above the transport belt 21 when the leveling step is performed, and may be configured to be detachable from the transport apparatus 2 when the leveling step is not performed.

The length of the blade 9 in the width direction of the transport belt 21 (the x-axis direction) is not particularly limited, but is preferably 50 cm or more and 300 cm or less, and more preferably 100 cm or more and 200 cm or less. According to this, the length of the blade 9 in the width direction of the transport belt 21 can be made equal to or longer than the width of the transport belt 21 regardless of the model of the textile printing apparatus 1 or the size of the transport belt 21. Therefore, the blade 9 can cover the entire area or an effective area in the width direction of the transport belt 21 to level the application liquid 100.

The leveling of the application liquid 100 by the blade 9 is performed while the transport belt 21 is driven to travel, and the traveling speed of the transport belt 21 at the time of leveling the application liquid 100 is substantially the same as the traveling speed of the transport belt 21 at the time of printing. According to this, control of the traveling speed of the transport belt 21 can be easily performed.

Here, “substantially the same” is a concept that includes not only a case where there is no difference between the two traveling speeds, but also a case where there is a slight difference between the two traveling speeds, for example, a case where the average speed difference is within ±5%.

Note that in the present disclosure, the traveling speed of the transport belt 21 at the time of printing may be different from the traveling speed of the transport belt 21 at the time of leveling the application liquid 100. That is, the traveling speed of the transport belt 21 may be changed as appropriate between the time of forming the coating film 105 and the time of printing.

As shown in FIG. 1, the adhesive drying section 10 is a section performing a drying step shown in FIG. 3, and is disposed below the transport belt 21.

The adhesive drying section 10 includes the coil 11 as a heat source (heater). The coil 11 is formed of, for example, a nichrome wire, and is a heating element generating heat by being supplied with electric power. The coating film 105 of the application liquid 100 applied to the application surface 210 and leveled by the blade 9 can be moderately dried by the heat generated by the coil 11.

Note that the disposed position of the adhesive drying section 10 is not limited to the configuration shown in the drawings. Further, the configuration of the adhesive drying section 10 is not limited to the configuration shown in the drawings.

In addition, in the present embodiment, a configuration in which the application liquid 100 is applied to the application surface 210 of the transport belt 21 once has been described, but this is not limiting, and it may be applied twice or three times. That is, after the supplying step, the leveling step, and the drying step of the application liquid 100 are performed, these steps may be repeated a plurality of times.

Note that the application step may be performed by applying the application liquid 100 using another apparatus or by an operator using an applicator or the like. In this case, examples of the applicator include a brush and an application roller.

The application step includes the leveling step in which the application liquid 100 is ejected from the nozzle and supplied to the application surface 210, and the supplied application liquid 100 is leveled using the blade 9. According to this, the application liquid 100 can be stably supplied to the application surface 210. Further, the supply of the application liquid 100 to the application surface 210 and the leveling of the application liquid 100 can be continuously performed.

In the present embodiment, a configuration in which the leveling step is performed using the blade 9 has been described, but the present disclosure is not limited thereto, and the leveling step may be performed by an operator using a tool such as a squeegee. Further, the leveling step itself may be omitted.

The adhesive layer forming method includes the drying step of heating and drying the coating film 105 of the application liquid 100 leveled in the leveling step. According to this, the coating film 105 can be quickly and uniformly dried, and a uniform and good adhesive layer having no unevenness in adhesiveness can be formed on the application surface 210 of the transport belt 21.

In the present embodiment, the adhesive drying section 10 executing the drying step can forcibly or quickly dry the coating film 105, but the present disclosure is not limited thereto, and the adhesive drying section 10 may perform drying at room temperature, natural drying without applying an air current, or the like. In addition, the transport apparatus 2 or the textile printing apparatus 1 may not include the adhesive drying section 10.

Although the preferred embodiments of the present disclosure have been described above, the present disclosure is not limited thereto.

For example, the transport belt and the textile printing apparatus of the present disclosure are not limited to the above-described configurations shown in the drawings, and the transport belt and each section of the textile printing apparatus can be replaced with any structure which can exhibit the same function. Further, any structure may be added.

### EXAMPLES

Next, specific examples of the present disclosure will be described.

### [3] Synthesis of (Meth)acrylic RESIN

### Synthesis Example 1

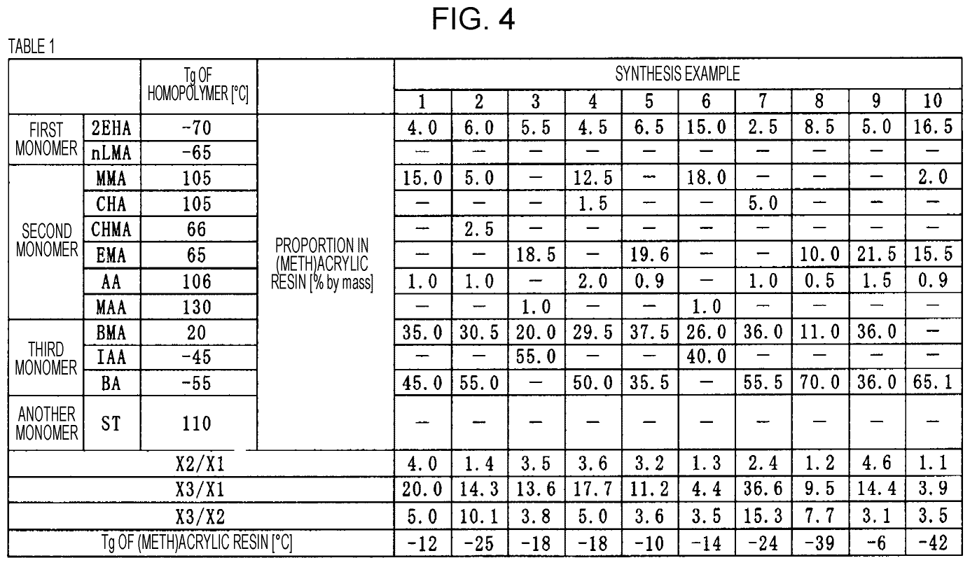

Ion exchanged water in an amount of 23 g was added to a reactor including a stirrer, a reflux cooling tube, a thermometer, a nitrogen introduction tube, and a dropping funnel, and was heated to 82° C. Thereafter, a total of 100 g of monomers obtained by weighing 4.0 parts by mass of 2-ethylhexyl acrylate, 15.0 parts by mass of methyl methacrylate, 1.0 part by mass of acrylic acid, 35.0 parts by mass of butyl methacrylate, and 45.0 parts by mass of butyl acrylate as monomer components so as to have the composition ratio shown in FIG. 4, 24.5 g of ion exchanged water, and 2.5 g of Eleminol CLS-20 (ammonium polyoxyalkylene alkyl ether sulfate, an anionic surfactant, manufactured by Sanyo Chemical Industries, Ltd.) were added, and the mixture was mixed and stirred. Into the uniformized solution, 50 g of a 2% by mass aqueous solution of ammonium persulfate as a polymerization initiator was charged at 82° C. over 1.5 hours. All kinds of the above-described components were charged, the solution was cooled after keeping the temperature for 1 hour, ion exchange water was added, and ammonia water as a pH adjuster was charged. Thereafter, the solution was filtered through a 150-mesh nylon filter to remove coarse particles, thereby obtaining an emulsion in which a (meth)acrylic resin having the composition shown in FIG. 4 was dispersed in water.

### Synthesis Examples 2 to 18

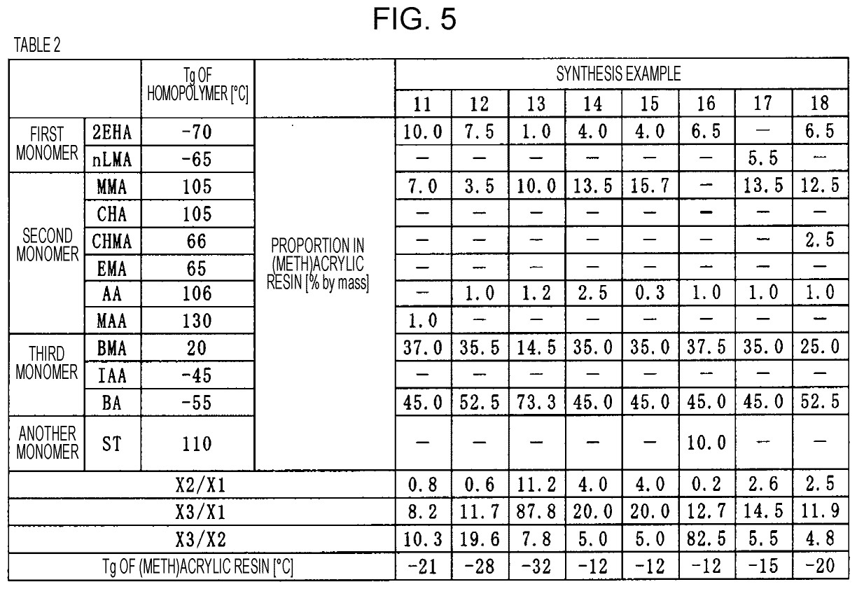

Emulsions in which a (meth)acrylic resin was dispersed in water were synthesized in the same manner as in Synthesis Example 1 except that the kinds and the used amounts of the raw material monomers were changed as shown in FIG. 4 and FIG. 5.

The kinds and the used amounts of the raw material monomers used in the respective synthesis examples are collectively shown in FIG. 4 and FIG. 5. In FIG. 4 and FIG. 5, 2-ethylhexyl acrylate is indicated as “2EHA,” lauryl methacrylate as “nLMA,” methyl methacrylate as “MMA,” cyclohexyl acrylate as “CHA,” cyclohexyl methacrylate as “CHMA,” ethyl methacrylate as “EMA,” acrylic acid as “AA,” methacrylic acid as “MAA,” butyl methacrylate as “BMA,” isoamyl acrylate as “IAA,” butyl acrylate as “BA,” styrene as “ST,” glass-transition temperature as “Tg,” the mass proportion of the first monomer in the (meth)acrylic resin as X1 [% by mass], the mass proportion of the second monomer in the (meth)acrylic resin as X2 [% by mass], and the mass proportion of the third monomer in the (meth)acrylic resin as X3 [% by mass].

### [4] Preparation of Aqueous Adhesive Composition for Textile Printing

### Example 1

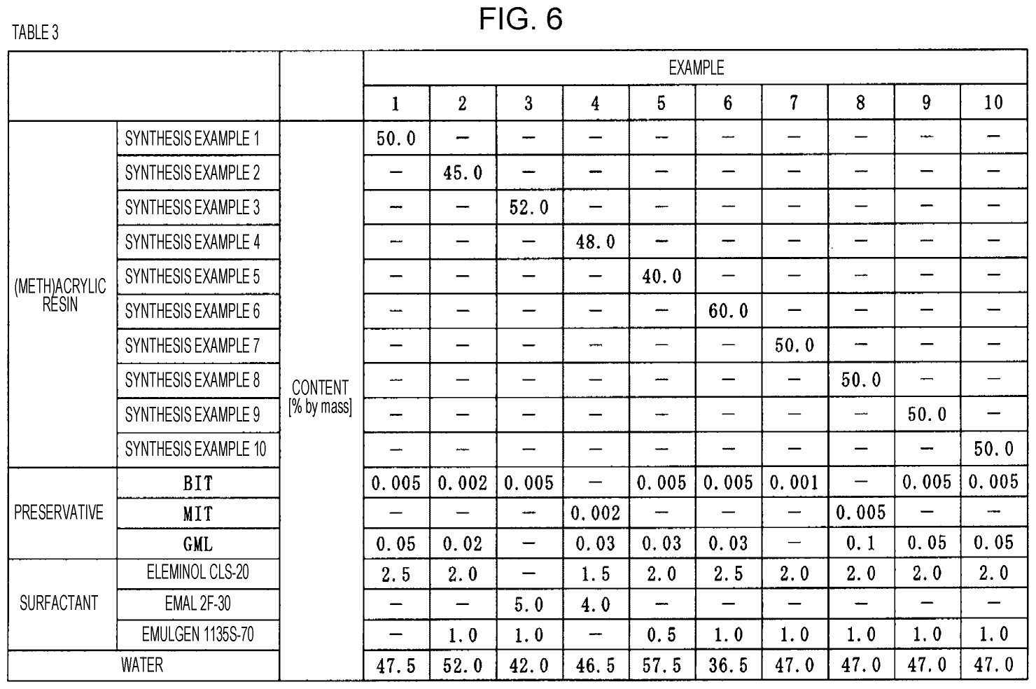

An aqueous adhesive composition for textile printing having a composition shown in FIG. 6 was obtained using the (meth)acrylic resin emulsion synthesized in Synthesis Example 1, 1,2-benzisothiazol-3(2H)-one as a preservative, and glycerol monolaurate as a preservative.

### Examples 2 to 18 and Comparative Example 1

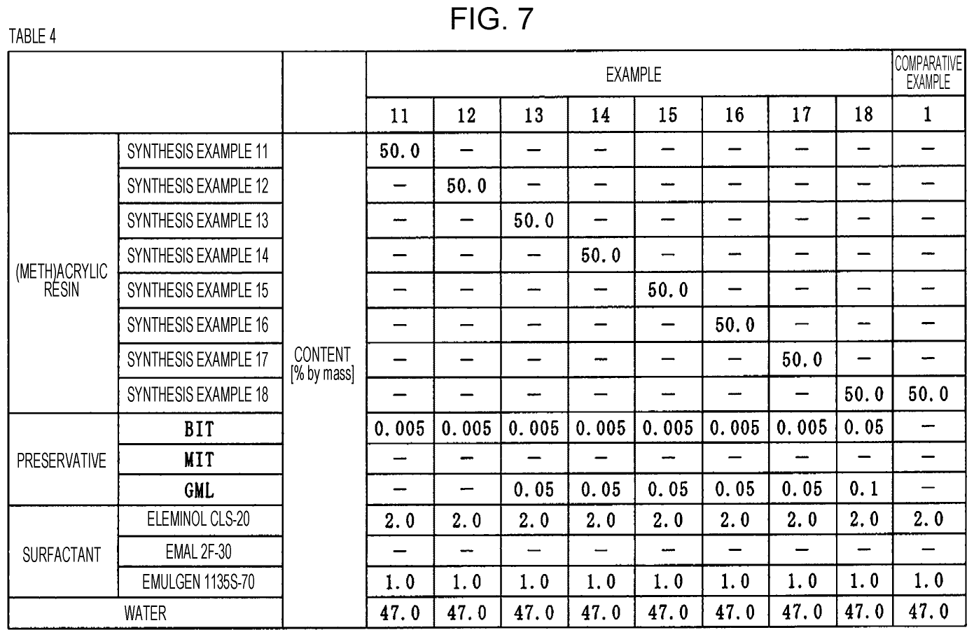

Aqueous adhesive compositions for textile printing were prepared in the same manner as in Example 1 except that the kind of the (meth)acrylic resin, the kind of the preservative, the kind of the surfactant, and the content of each component were as shown in FIG. 6 and FIG. 7.

The compositions of the aqueous adhesive compositions for textile printing of Examples and Comparative Example are collectively shown in FIG. 6 and FIG. 7. In FIG. 6 and FIG. 7, 1,2-benzisothiazol-3(2H)-one is indicated as “BIT,” methylisothiazolinone is indicated as “MIT,” and glycerol monolaurate is indicated as “GML.”

### [5] Formation of Adhesive Layer

The textile printing apparatus shown in FIG. 1 was prepared, and the aqueous adhesive composition for textile printing was ejected from the application liquid supply section toward a transport belt, which was an endless belt having a surface of a urethane material, in an environment of 23° C., leveled with a blade, applied so as to be 0.2 mm thick, and dried under conditions of 50% RH, 23° C., and 12 hours to form an adhesive layer.

### [6] Evaluation

### [6-1] Evaluation of Aqueous Adhesive Composition for Textile Printing

The aqueous adhesive compositions for textile printing according to Examples and Comparative Example were evaluated as follows.

### [6-1-1] Storage Stability

The aqueous adhesive composition for textile printing was put in a sample container, which was sealed and left to stand in a thermostatic chamber at 60° C. for 4 weeks, and the state was visually observed, and evaluated according to the following criteria.
A: No aggregate formation is observed.
B: Although aggregates are slightly observed, they can be uniformly dispersed by stirring with shaking.
C: Aggregated precipitates are formed, and uniform dispersion is difficult even by stirring with shaking.
D: Solidification or discoloration occurs in all or part of the aqueous adhesive composition for textile printing.

### [6-1-2] Preservative Properties

Each of the aqueous adhesive compositions for textile printing of Examples and Comparative Example was extracted in 1 g, cultured on an agar culture medium at 30° C. for 4 weeks, and evaluated according to the following criteria.
A: The number of bacteria and/or fungi is 10 or less.
B: The number of bacteria and/or fungi is 11 or more and 100 or less.
C: The number of bacteria and/or fungi is 101 or more and 1,000 or less.
D: The number of bacteria and/or fungi is 1,001 or more.

### [6-2] Evaluation of Adhesive Layer

The adhesive layers according to Examples and Comparative Example were evaluated as follows.

### [6-2-1] Fabric Adhesion Properties

In the textile printing apparatus shown in FIG. 1, a long fabric wound in a roll shape was fed from the feeding apparatus, tension was applied to the fed fabric by the tensioners, and the fabric was attempted to be transported in a state of being pressed onto the adhesive layer of the transport belt provided with the adhesive layer. As the fabric, a British-made see-through organza fabric, which was a fabric resistant to sticking and weak against pulling, and a 100% cotton fabric, which was a fabric easily sticking, were used. Evaluation was made according to the following criteria.
A: Both the organza fabric and the cotton fabric can be transported.
B: Although the cotton fabric can be transported, the organza fabric cannot be transported.
C: Neither the cotton fabric nor the organza fabric can be transported.

### [6-2-2] Fabric Peelability

In a state where the fabric was mounted on the adhesive layer of the transport belt provided with the adhesive layer, the transport belt and the fabric were brought into close contact with each other via the adhesive layer by applying a pressure of 10 kPa for 1 second. As the fabric, a British-made see-through organza fabric, which was a fabric resistant to sticking and weak against pulling, and a 100% cotton fabric, which was a fabric easily sticking, were used. Thereafter, the fabric was pulled up in the normal direction (a direction of) 90° of the adhesive layer at a speed of 4 m/minute (a low speed) and a speed of 8 m/minute (a high speed) to attempt peeling from the adhesive layer, and evaluation was performed according to the following criteria.
A: Both the organza fabric and the cotton fabric can be peeled off at the high speed without adhesion of the adhesive.
B: At least one of the organza fabric and the cotton fabric cannot be peeled off at the high speed without adhesion of the adhesive, but both the organza fabric and the cotton fabric can be peeled off at the low speed without adhesion of the adhesive.
C: When the peeling is performed at the low speed, the adhesive adheres to the fabric or the fabric is irreversibly stretched.

### [6-2-3] Mechanical Strength

The adhesive layer provided on the transport belt was subjected to brush washing with water using a digital textile printing machine (ML-8000, manufactured by Seiko Epson Corporation). The state of the adhesive layer when the fabric was transported by 10,000 m was visually observed, and evaluated according to the following criteria.
A: No scratches or peeling is observed.
B: Slight scratches are observed.
C: Significant unevenness or film peeling is observed.

### [6-2-4] Water Resistance

After the textile printing apparatus including the transport belt provided with the adhesive layer shown in FIG. 1 was continuously operated for 8 hours, the state of the adhesive layer was visually observed, and evaluated according to the following criteria. It can be said that the larger the degree of whitening, the lower the adhesive strength and the poorer the water resistance.
A: No whitening occurs, and the sample is transparent.
B: Slight whitening occurs.
C: Significant whitening occurs.

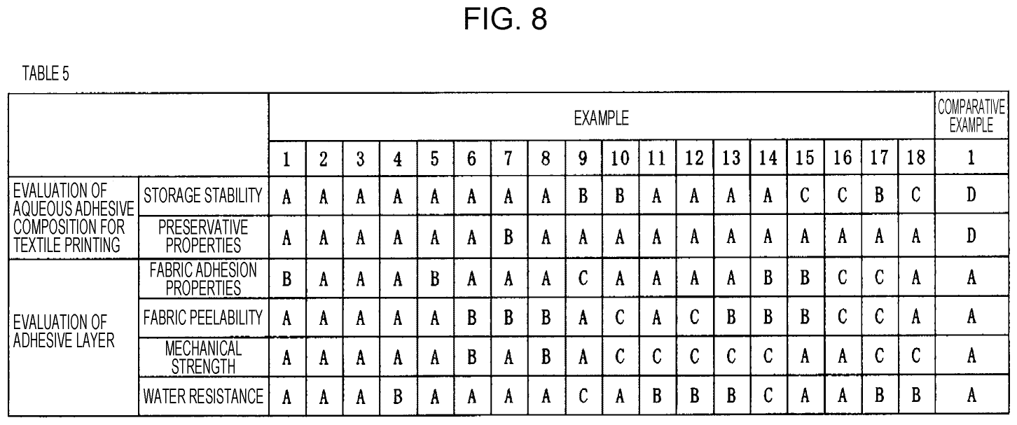

These results are collectively shown in FIG. 8.

As is clear from FIG. 8, excellent results were obtained in Examples. In contrast, satisfactory results were not obtained in Comparative Example.

What is claimed is:

1. An aqueous adhesive composition for textile printing, comprising water, a (meth)acrylic resin, and a preservative.

2. The aqueous adhesive composition for textile printing according to claim 1, wherein the (meth)acrylic resin has a glass transition temperature of −40° C. or higher and −10° C. or lower.

3. The aqueous adhesive composition for textile printing according to claim 1, wherein
the (meth)acrylic resin contains, as a constituent monomer, a first monomer having a glass transition temperature when formed into a homopolymer of −60° C. or lower, and
a proportion of the first monomer in all monomers constituting the (meth)acrylic resin is 2.0% by mass or more and 15.0% by mass or less.

4. The aqueous adhesive composition for textile printing according to claim 1, wherein
the (meth)acrylic resin contains, as a constituent monomer, a second monomer having a glass transition temperature when formed into a homopolymer of 40° C. or higher, and
a proportion of the second monomer in all monomers constituting the (meth)acrylic resin is 5.0% by mass or more and 20.0% by mass or less.

5. The aqueous adhesive composition for textile printing according to claim 1, wherein
the (meth)acrylic resin contains, as constituent monomers, a first monomer having a glass transition temperature when formed into a homopolymer of −60° C. or lower and a second monomer having a glass transition temperature when formed into a homopolymer of 40° C. or higher, and
a mass proportion of the second monomer in the (meth)acrylic resin is larger than a mass proportion of the first monomer.

6. The aqueous adhesive composition for textile printing according to claim 5, wherein the (meth)acrylic resin contains, as a constituent monomer, a third monomer having a glass transition temperature when formed into a homopolymer of higher than −60° C. and lower than 40° C., in addition to the first monomer and the second monomer.

7. The aqueous adhesive composition for textile printing according to claim 4, comprising a monomer having an acidic functional group as the second monomer.

8. The aqueous adhesive composition for textile printing according to claim 1, wherein a content of the preservative is 0.001% by mass or more and 0.10% by mass or less.

9. The aqueous adhesive composition for textile printing according to claim 1, wherein the preservative is an organic preservative.

10. A transport belt transporting a fabric on which printing by textile printing is performed, the transport belt comprising:
an adhesive layer formed of a material containing a (meth)acrylic resin and a preservative on a surface being in contact with the fabric.

11. A textile printing apparatus comprising:
the transport belt according to claim 10; and
an ink jet head including a nozzle ejecting ink onto the fabric being transported by the transport belt.
